(19) United States
(12) Patent Application Publication
(10) Pub. No.: US 2010/0221806 A1
(43) Pub. Date: Sep. 2, 2010

(54) APPARATUS AND METHOD FOR GROWING PLANTS, A BIOMASS, OR MICRORGANISMS IN WATER THROUGH PHOTOSYNTHESIS

(76) Inventors: Chaim Lieberman, Brooklyn, NY (US); Israel Horowitz, Bat Ayin (IL)

Correspondence Address: DANIEL J SWIRSKY, 55 REUVEN ST., BEIT SHEMESH, 99544, IL

(21) Appl. No.: 12/673,509

(22) PCT Filed: Aug. 15, 2008
(86) PCT No.: PCT/US08/09794

§ 371 Date: May 16, 2010

Related U.S. Application Data
(60) Provisional application No. 60/964,839, filed on Aug. 15, 2007.

(51) Int. Cl. C12N 13/00; C12M 1/02; A01G 31/02

(52) U.S. Cl. 435/173.8; 435/292.1; 47/59 R

(57) ABSTRACT

Presented is an apparatus for growing plants, a biomass, or a microorganism through photosynthesis. The apparatus includes a hollow tube-like structure of flexible transparent material having a first end, a second end, and a middle section, and defining an interior for receiving, through one of the ends, an aqueous solution, a gas comprising carbon dioxide, and at least one of seeds of the plants, a sample of the biomass, and a sample of the microorganism to be grown. The apparatus further includes a support connected to the first or second end of the tube-like structure for positioning the first or second end at a height above the middle section, and an agitator connected to the tube-like structure to impart motion to the aqueous solution in the interior such that when the tube-like structure is exposed to electromagnetic radiation, growth of the plants, biomass, or microorganism occurs through photosynthesis.

### CROSS REFERENCE TO RELATED CASES

This application claims priority to, and the benefit of, U.S. provisional Patent Application Ser. No. 60/964,839, filed Aug. 15, 2007, the entirety of which is incorporated herein by reference.

### BACKGROUND OF THE INVENTION

1. Field of the Invention

This application claims priority to, and the benefit of, U.S. provisional Patent Application Ser. No. 60/964,839, filed Aug. 15, 2007, the entirety of which is incorporated herein by reference.

2. Description of the Related Art

Photosynthesis is the transformation of carbon dioxide into primary hydrocarbon material, as a result of electromagnetic radiation such as solar energy, where oxygen is the main by-product of the biochemical transformation. This process occurs in plants and some microorganisms such as algae. To ensure an optimum development of the plants and microorganisms, it is necessary to create or maintain a plant or microorganism-friendly environment including suitable temperature, electromagnetic radiation exposure, carbon dioxide, pH, and other nutrition such as nitrogen.

U.S. Pat. No. 5,534,417 discloses a method of growing micro-algae outdoors using a plurality of vertical elongated transparent flexible cells in close juxtaposition to one another to form a single compact body. The plurality of cells are connected to each other through welding. The single compact body is supported by vertical posts. Harvesting is effected by withdrawing 50% of the solution in the flexible cells to a tank through a pump and a pipe. The withdrawn solution is then left for about 12-24 hours to allow the solid micro-algae to separate from the solution. The harvesting procedure described in U.S. Pat. No. 5,534,417 is laborious and time-consuming. In addition, the apparatus described therein is complicated, and the growing environment created and maintained in the apparatus of U.S. Pat. No. 5,534,417 is not satisfactory.

Therefore, there is a need to develop a practical, simple, and cost-effective approach on an industrial scale for growing plants or microorganisms through photosynthesis in a more plant or microorganism friendly environment.

### SUMMARY OF THE INVENTION

In one aspect, the invention involves an apparatus for growing plants, a biomass, or a microorganism through photosynthesis. The apparatus includes a hollow tube-like structure of flexible transparent material that has a first end, a second end, and a middle section, and defines an interior for receiving, through one of the first and second ends, an aqueous solution, a gas including carbon dioxide, and at least one of seeds of the plants, a sample of the biomass and a sample of the microorganism to be grown. The apparatus further includes a support connected to the first or second end of the tube-like structure for positioning the first or second end at a height above the middle section, and an agitator connected to the tube-like structure and designed to impart motion to the aqueous solution in the interior such that when the tube-like structure is exposed to electromagnetic radiation, growth of the plants, biomass or microorganism occurs through photosynthesis.

In one embodiment, the agitator includes means for pressing on the tube-like structure to impart current to the aqueous solution. In another embodiment, the support is connected to the first and second ends of the tube-like structure for positioning the first and second ends at a height above, the middle section. In still another embodiment, the agitator includes a mechanism for raising and lowering one of the first and second ends of the tube-like structure. In yet another embodiment, the agitator includes a piston positioned at one of the first and second ends of the tube-like structure. In other embodiments, the first and second ends of the tube-like structure are sealed. In another embodiment, the apparatus further includes a source of carbon dioxide connected to the tube-like structure for providing a supply of carbon dioxide to the interior of the tube-like structure. In yet another embodiment, the agitator is connected to the first end of the tube-like structure and the second end of the tube-like structure is sealed.

In another aspect, the invention involves a method for growing plants, a biomass, or a microorganism through photosynthesis. The method includes disposing an aqueous solution, a gas comprising carbon dioxide, and at least one of seeds of the plants, a sample of the biomass and a sample of the microorganism to be grown in an interior of a hollow tube-like structure of flexible transparent material having a first end, a second end, and a middle section which defines the interior. The method further includes positioning the first or second end of the hollow tube-like structure at a height above the middle section, agitating the tube-like structure to impart motion to the aqueous solution in the interior, exposing the tube-like structure with the aqueous solution disposed therein, to electromagnetic radiation to cause growth of the plants, biomass or microorganism to occur through photosynthesis, and removing the aqueous solution from the tube-like structure after growth of the plants, biomass or microorganism has occurred, and separating the grown plants, biomass or microorganism from the removed aqueous solution.

In one embodiment, the method further includes the step of sealing one or both ends of the tube-like structure. In another embodiment, the step of agitating is performed by pressing on the tube-like structure to impart current to the aqueous solution. In still another embodiment, the step of agitating is performed by raising and lowering one of the first and second ends of the tube-like structure. In yet another embodiment, the step of agitating includes disposing a piston in one end of the tube-like structure and alternating insertion and withdrawal of the piston from the one end.

In still another aspect, the invention involves an apparatus for growing plants, a biomass, or a microorganism through photosynthesis. The apparatus includes a hollow tube-like structure that includes a bottom portion formed of rigid molded transparent material and a top portion formed of a flexible transparent material. The bottom portion has a curved U shape. The hollow tube-like structure has a first end, a second end, and a middle section, and defines an interior for receiving, through one of the first and second ends, an aqueous solution, a gas comprising carbon dioxide, and at least one of seeds of the plants, a sample of the biomass and a sample of the microorganism to be grown. The apparatus further includes a support configured for supporting the bottom portion so that the first end and second end are positioned at a height above the middle section, and an agitator connected to the tube-like structure and designed to impart motion to the aqueous solution in the interior such that when the tube-like structure is exposed to electromagnetic radiation, growth of the plants, biomass or microorganism occurs through photosynthesis.

### BRIEF DESCRIPTION OF THE DRAWINGS

In the drawings, like reference characters refer to the same parts throughout the different views. Also, the drawings are not necessarily to scale, emphasis instead generally being placed upon illustrating the principles of the invention.

FIG. 1 is an illustrative diagram of a sheet of plastic material coated with a plurality of seeds of plants, a sample of a biomass, or a sample of a microrganism to be grown, according to one embodiment of the invention.

FIG. 2 is an illustrative diagram of the sheet of plastic material of FIG. 1 rolled into a tube.

FIG. 3 is an illustrative diagram of a tube of plastic material shown with the ends sealed to form a bag.

FIG. 4 is an illustrative diagram of the bag of FIG. 3 with both ends of the bag suspended above a middle section of the bag.

FIG. 5 is an illustrative diagram of the bag of FIG. 3 with both ends of the bag suspended above a middle section of the bag and including an agitator at one end, according to another embodiment of the invention.

FIG. 6 is an illustrative diagram of a bag including airflow holes, according to another embodiment of the invention.

FIG. 7 is an illustrative diagram of the bag of FIG. 3 with both ends of the bag suspended above a middle section of the bag and including an external agitator disposed over the middle section, according to another embodiment of the invention.

FIG. 8 is an illustrative diagram of a curved bag of semi-rigid plastic material including a pump, according to another embodiment of the invention.

### DETAILED DESCRIPTION OF THE PRESENTLY PREFERRED EMBODIMENTS

The present invention provides an apparatus and method for growing plants, a biomass, or microorganisms in an aqueous environment through photosynthesis.

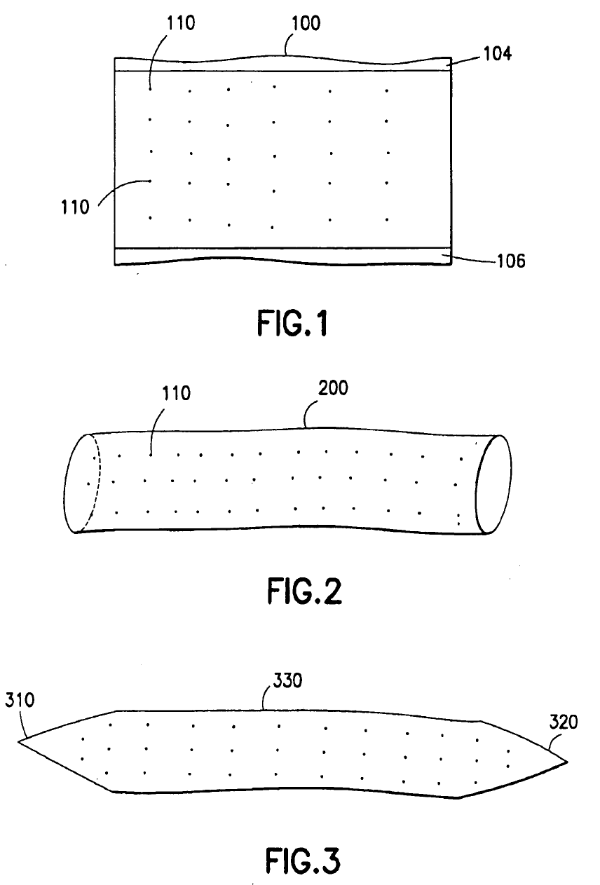

Referring to FIGS. 1-3, the apparatus includes a substrate 100 such as a piece of flexible transparent material. The substrate is generally formed into a tube 200 as shown in FIG. 2 having opened ends. The substrate comprises polyethylene. More preferably, the substrate 100 is formed from a sheet of polyethylene layered with nylon for increasing flexibility and durability of the substrate 100. One end 310 of the tube 200 is sealed and an aqueous solution along with seeds of a plant, a sample of the biomass, or a sample of the microorganism to be grown (generally shown as 110) and along with a gas comprising carbon dioxide are disposed in the interior of the tube 200 through the opened second end 320 which, optionally, may thereafter also be sealed.

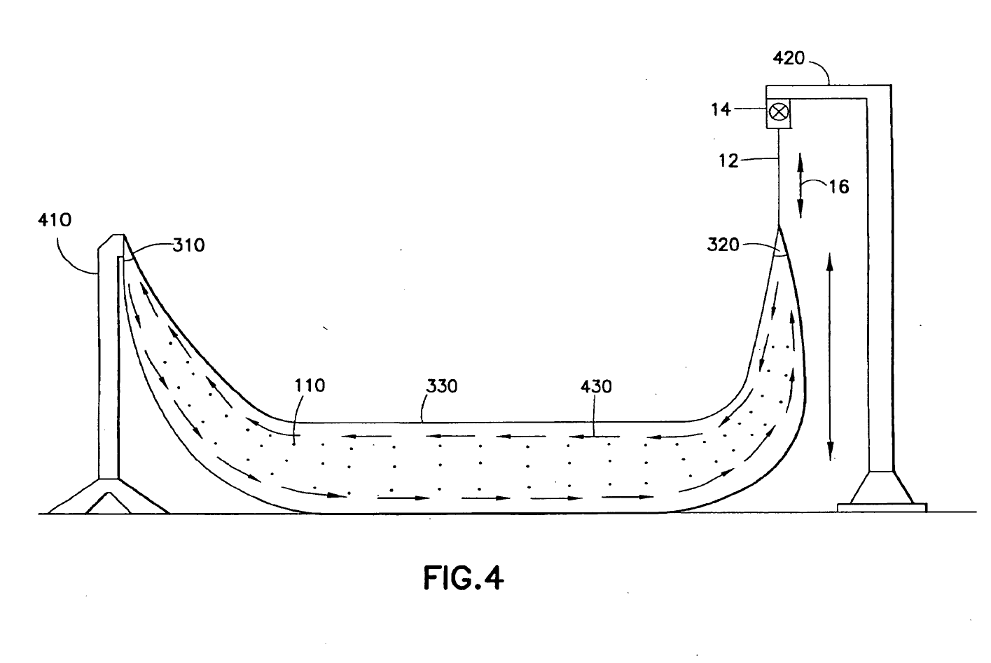

Referring to FIG. 4, the substrate pouch or bag 300 is disposed in a horizontal position and at least one of the ends 310, namely the opened second end 320—if it was not sealed—or either end if both were sealed, is/are suspended relative to a middle section of the bag by one or more supports or members 410 and 420 to cause circulation of the contents of the bag 330 as shown by arrows 430. In one embodiment, the circulation can occur by raising and lowering an end 320 of the bag by attaching a cord 12 for example, to a motor 14 for moving the end in the directions shown by arrow 16 to cause a minor current or turbulence to the aqueous solution in the bag. The bag 330 is then exposed to electromagnetic radiation such as sunlight and the plurality of seeds of the plants, the sample of the biomass, or the sample of the microrganism 110, in the presence of the aqueous solution and the carbon dioxide, grow and generate oxygen through photosynthesis.

Rather than the substrate 100 formed initially as a tube 200 and the aqueous solution and plant seeds or biomass or microorganism sample disposed therein, the substrate can be in the form of a sheet as shown in FIG. 1. In one embodiment, the sheet is coated on one surface with a material that adheres to the surface of the sheet. The seeds or biomass or microorganisms sample are then embedded in the material so that the seeds, for example are affixed or anchored to the surface of the sheet. In another embodiment, seeds or biomass or microorganisms sample are embedded in a separate layer of material that affixed to the sheet so that the seeds, for example are affixed or anchored to the surface of the sheet. Thereafter, the sheet is folded to form a tube shape, such as by overlapping sheet edges 104, 106 with each other. Thereafter, one or both ends can be sealed and elevated as described above and the aqueous solution added.

Irrespective of whether the seeds or organic samples are added to the tube with the aqueous solution or adhered to the sheet prior to adding the aqueous solution, the first and second ends of the tube need not be sealed. Rather, the ends can be simply raised relative to the middle section of the tube, such as in a “U” shape which will keep the contents inside the tube while allowing gases to enter and exit the tube via the opened ends.

The plants, the biomass, or the microrganism 110 grow for a period of time and are then harvested. This is accomplished by unsealing the ends of the tube 330 or simply lowering an already opened end, draining the aqueous solution and collecting the plants, the biomass, or the microrganism 110. One technique to accomplish the harvesting is by opening the bag at one end and draining the contents into a strainer or sieve which will collect the plant, biomass or microorganisms. The now-empty tube can be discarded along with the aqueous solution. Preferably, however, the aqueous solution and tube can be reused.

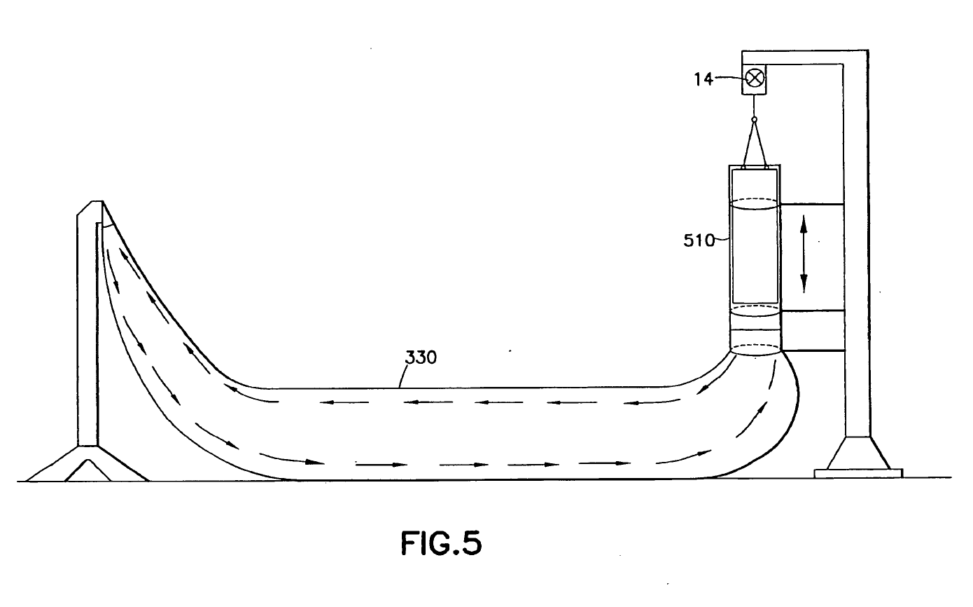

Referring to FIG. 5, in another embodiment, a piston 510 is interfaced with an end of the bag 330 and connected to a motor 14 which withdraws and inserts the piston from and into the end of the bag to create a pressure wave (indicated by arrows 530) to circulate the gas and aqueous solution inside the bag 330. The piston 510 can include a smaller tube (not shown) connected to an air source for supplying additional carbon dioxide to the interior of the tube.

As discussed above, the bag 330 may be made of transparent, thin, flexible plastic material with suitable mechanical and optical properties such as polyethylene, polyamides, and PVC. The material forming the bag 330 is preferably made or modified to prevent the bag 330 from disintegrating due to the effect of ultraviolet light. For example, the material forming the bag 330 may be coated with an anti-ultraviolet layer.

In another embodiment, to increase the temperature within the bag 330 during winter, an extra layer may be used to cover the bags, in particular, the upper part of the bags. The extra layer may be made of a plastic material, which can be the same as, or different from, the material of the bag 330 itself.

In another embodiment, a plurality of bags 330 may be placed horizontally into a hydroponic field. In this way, a large area hydroponic field may be covered by a plurality of bags 330 easily at a low cost. Each of the bags 330 may preferably have a circumference of about one meter. The length of each of the bags 330 does not have to be limited.

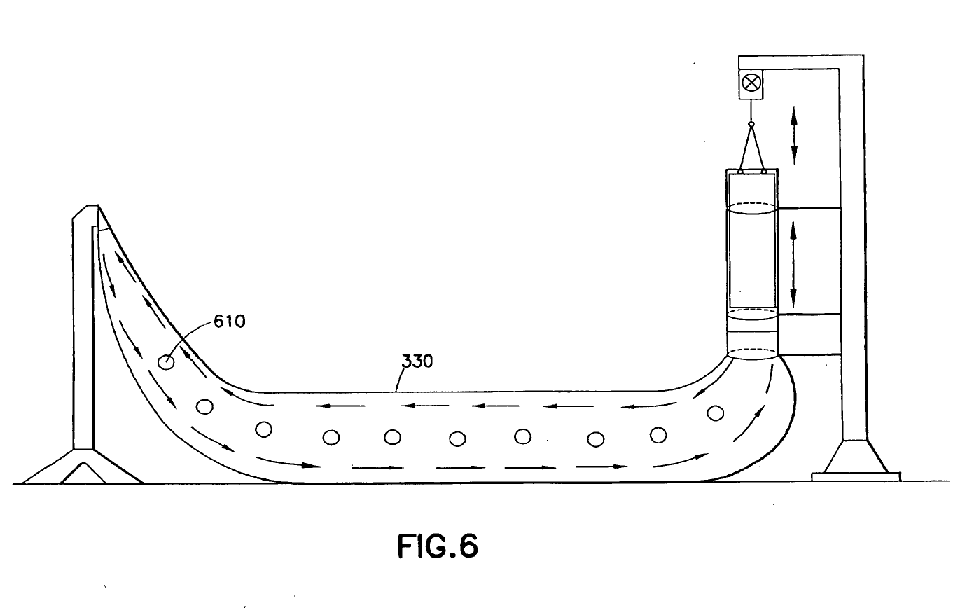

Referring to FIG. 6, in still another embodiment, a plurality of holes 610 are made in the bag 330 so that air can flow into the bags from outside.

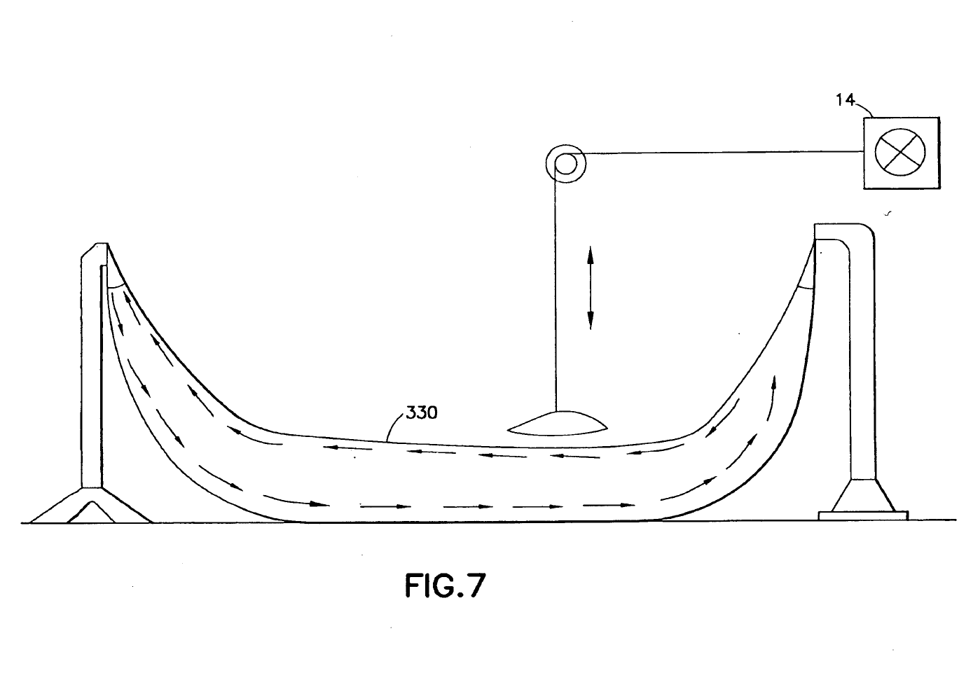

Referring to FIG. 7, in still another embodiment, an air or carbon dioxide pump can be used to provide an effective amount of carbon dioxide into the bags. Still other techniques can be used to agitate the contents of the tube. For example, instead of lifting an end of the tube as in FIG. 4 or using a piston as in FIG. 5, the embodiment of FIG. 7 uses a simple member such as a weight connected to a motor for moving the weight into and out of contact with the surface of the flexible tube, thereby imparting flow to the contents of the tube.

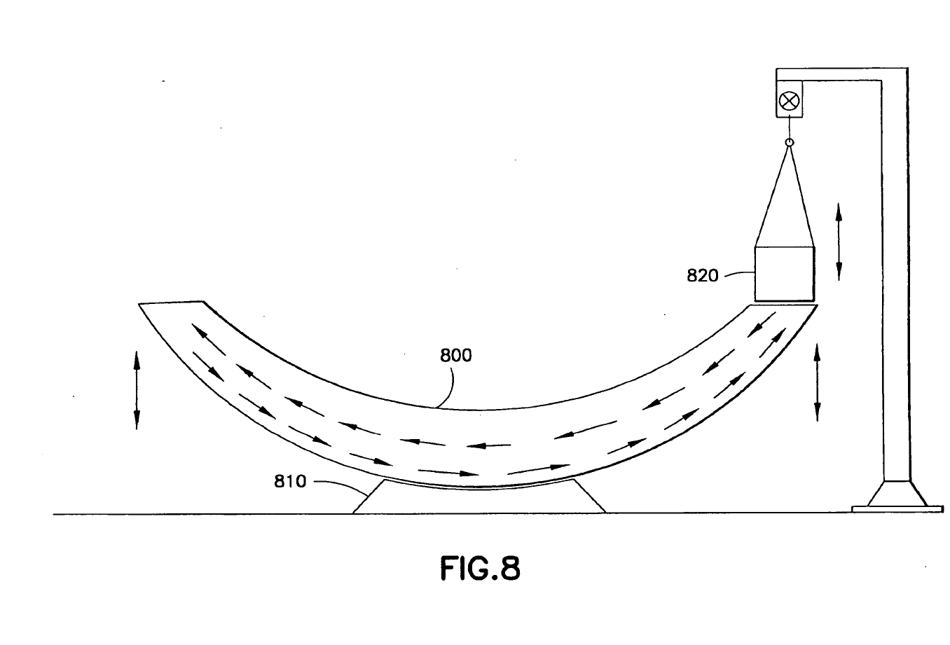

Referring to FIG. 8, in yet another embodiment, a bag 800 is shown. The bag 800 has a bottom portion made of a semi-rigid transparent material and a top portion made of flexible transparent material. The semi-rigid material and the flexible material are formed into a tube. One or both ends of the tube may be closed or sealed and the ends are bent into a curved “U” shape and placed on a stand 810. A plurality of seeds of the plants, a sample of the biomass, or a sample of the microrganism to be grown are disposed therein along with an aqueous solution and a gas comprising carbon dioxide. An optional agitator 820 can be interfaced with the inside of the bag 800 to circulate the gas inside the bag 800, or a motor 14 can be used to agitate the bag such as by lifting and lowering an end.

The suitable environment for growing the plants or organisms may include a desired temperature, an effective amount of carbon dioxide, sufficient sunlight exposure, and an effective amount of nutrition such as nitrogen. For example, an aqueous medium containing the microorganisms may be constantly charged with dissolved carbon dioxide and nitrogen at an optimum level throughout the culture and the development of the microorganisms or plants. Likewise, the temperature and pH of the aqueous medium containing the microorganisms or plants may be regulated or maintained based on the specific needs of different plants, biomass, or microorganisms. Oxygen resulting from the photosynthesis, which is harmful to the growth of the plants, biomass, or microorganisms, may need to be removed from the bags. Nitrogen may be supplied in the form of nitrate to the aqueous medium.

Compared to the use of vertical tubes used in existing systems, harvesting of the plants, the biomass, or the microrganism is significantly easier, in the present invention. Solar energy can be utilized more efficiently, and less energy is needed to feed an effective amount of aqueous nutrition, due to the use of horizontal plastic bags.

Variations, modifications, and other implementations of what is described herein may occur to those of ordinary skill in the art without departing from the spirit and scope of the disclosed subject matter. Further, the various features of the embodiments described herein also can be combined, rearranged, or separated without departing from the spirit and scope of the disclosed subject matter. Accordingly, the invention is not to be defined only by the preceding illustrative description.

What is claimed is:

1. An apparatus for growing plants, a biomass, or a microorganism through photosynthesis, comprising:
a hollow tube-like structure of flexible transparent material having a first end, a second end, and a middle section, and defining an interior for receiving, through one of the first and second ends, an aqueous solution, a gas comprising carbon dioxide, and at least one of seeds of the plants, a sample of the biomass, and a sample of the microorganism to be grown;
a support connected to the first or second end of the tube-like structure for positioning the first or second end at a height above the middle section; and
an agitator connected to the tube-like structure and designed to impart motion to the aqueous solution in the interior such that when the tube-like structure is exposed to electromagnetic radiation, growth of the plants, biomass or microorganism occurs through photosynthesis.

2. The apparatus of claim 1, wherein the agitator comprises means for pressing on the tube-like structure to impart current to the aqueous solution.

3. The apparatus of claim 1, wherein the support is connected to the first and second ends of the tube-like structure for positioning the first and second ends at a height above the middle section.

4. The apparatus of claim 1, wherein the agitator comprises a mechanism for raising and lowering one of the first and second ends of the tube-like structure.

5. The apparatus of claim 1, wherein the agitator comprises a piston positioned at one of the first and second ends of the tube-like structure.

6. The apparatus of claim 1, wherein the first and second ends of the tube-like structure are sealed.

7. The apparatus of claim 6, further comprising a source of carbon dioxide connected to the tube-like structure for providing a supply of carbon dioxide to the interior of the tube-like structure.

8. The apparatus of claim 1, wherein the agitator is connected to the first end of the tube-like structure and wherein the second end of the tube-like structure is sealed.

9. A method for growing plants, a biomass, or a microorganism through photosynthesis, comprising:
disposing an aqueous solution, a gas comprising carbon dioxide, and at least one of seeds of the plants, a sample of the biomass and a sample of the microorganism to be grown in an interior of a hollow tube-like structure of flexible transparent material having a first end, a second end, and a middle section which defines the interior;
positioning the first or second end of the hollow tube-like structure at a height above the middle section;
agitating the tube-like structure to impart motion to the aqueous solution in the interior;
exposing the tube-like structure with the aqueous solution disposed therein, to electromagnetic radiation to cause growth of the plants, biomass or microorganism to occur through photosynthesis;
removing the aqueous solution from the tube-like structure after growth of the plants, biomass or microorganism has occurred; and
separating the grown plants, biomass or microorganism from the removed aqueous solution.

10. The method of claim 9, further comprising the step of sealing one or both ends of the tube-like structure.

11. The method of claim 9, wherein the step of agitating is performed by pressing on the tube-like structure to impart current to the aqueous solution.

12. The method of claim 9, wherein the step of agitating is performed by raising and lowering one of the first and second ends of the tube-like structure.

13. The method of claim 9, wherein the step of agitating comprises disposing a piston in one end of the tube-like structure and alternating insertion and withdrawal of the piston from the one end.

14. An apparatus for growing plants, a biomass, or a microorganism through photosynthesis, comprising:
a hollow tube-like structure comprising a bottom portion formed of rigid molded material and a top portion formed of a flexible transparent material, the bottom portion having a curved U shape, the hollow tube-like structure having a first end, a second end, and a middle section, and defining an interior for receiving, through one of the first and second ends, an aqueous solution, a gas comprising carbon dioxide, and at least one of seeds of the plants, a sample of the biomass and a sample of the microorganism to be grown;
a support configured for supporting the bottom portion so that the first end and second end are positioned at a height above the middle section; and
an agitator connected to the tube-like structure and designed to impart motion to the aqueous solution in the interior such that when the tube-like structure is exposed to electromagnetic radiation, growth of the plants, biomass or microorganism occurs through photosynthesis.
